(19) United States
(12) Patent Application Publication
(10) Pub. No.: US 2019/0039109 A1
(43) Pub. Date: Feb. 7, 2019

(54) Device for Producing Hardened Steel Components and Hardening Method

(71) Applicants: voestalpine Stahl GmbH, LINZ (AT); voestalpine Metal Forming GmbH, KREMS AN DER DONAU (AT)

(72) Inventors: MICHAEL HASLMAYR, Gutau (AT); ANDREAS SOMMER, Abtsgmünd (DE); REINER KELSCH, Mutlangen (DE); BENEDIKT TUTEWOHL, Durlangen (DE); LEOPOLD STEGFELLNER, Wartberg ob der Aist (AT)

(21) Appl. No.: 16/073,980

(22) PCT Filed: Feb. 3, 2017
(86) PCT No.: PCT/EP2017/052445

§ 371 Date: Jul. 30, 2018

(30) Foreign Application Priority Data
Feb. 4, 2016 (DE) 10 2016 101 975.5

(51) Int. Cl. B21D 22/02; B21D 37/16; C21D 1/40; C21D 9/46; C21D 1/18

(52) U.S. Cl. CPC B21D 22/022; B21D 37/16; H05B 3/68; C21D 9/46; C21D 1/18; C21D 1/40

(57) ABSTRACT

The invention relates to an apparatus for heating sheet steel blanks, in particular for shaping and hardening in a press hardening process, wherein there is a heating device, and the heating device includes at least one heating module; the at least one heating module has a boxlike element embodied in cassette-like fashion, which has a plate-shaped or rectangular cavity that has a flat plate on an underside; at least one heating element is positioned in the cavity, which element is embodied as an electrical resistance heating element, and the cavity is completely filled in an embedding fashion so that it is completely enclosed by a highly heat-conductive material, preferably copper, and relates to a method therefor.

The invention relates to a method and an apparatus for producing hardened sheet steel blanks and sheet steel components.

It has long been known, including in automotive engineering, to use hardened components for sheet steel vehicle body parts. The advantage of hardened sheet steel components is that because of their considerably higher hardness and tensile strength (Rₘ), they achieve a weight reduction in vehicle body manufacture, since there is no need to use less-strong and therefore massive components, which would be much heavier.

In years past, two methods for producing hardened sheet metal components have become established on the market.

The first method is the so-called direct method or press hardening. In this method, a blank is stamped out of a sheet steel band, which may also be provided with an anticorrosion coating made of metal, this blank is then heated, and the heated blank is shaped in a shaping tool and at the same time hardened, all in a single stroke. The hardening takes place because the hardenable steel material imparts its heat to the shaping tool. It is important here that the imparting of heat occurs at a speed that lies above the critical hardening temperature. The effect of this quench hardening is that the heated blank, which has an austenitic microstructure, subsequently has an essentially martensitic microstructure and thus high tensile strength.

In this method, so-called boron-manganese steels are typically used, in other words boron-alloy manganese carbon steels, such as 22MnB5, which is the most widely used, but there are also a number of other steels suitable for the purpose based on fundamentally the same alloying concept.

In the second method, known as form hardening, which was developed by the applicant, a sheet steel blank is cut out of a sheet steel band, the latter possibly provided with an anticorrosion coating, and this sheet steel blank is then shaped in a conventional, multi-stage shaping process to form a component. This component preferably has a final contour that is smaller in all directions in space by approximately 2% than the finished contour of the component. Next, this component is heated to the austenitization temperature, so that the sheet steel microstructure becomes austenitic. The heat expansion in this case causes this heated sheet metal component to compensate for the 2% reduction in production size.

Next, this austenitic sheet metal component is placed in a form-hardening tool, in which it is pressed and simultaneously cooled, but is practically no longer shaped, or is only shaped to a very slight extent. Here again, the aforementioned steels are used, and also here, the critical hardness speed must be exceeded. The microstructure then also results in the same way.

The advantage of the indirect method or form hardening is that geometries of even greater complexity can be achieved.

The advantage of the so-called direct method, or press hardening, is that simple components can be produced more quickly.

When using the direct press hardening process, one challenge is heating the blank.

Typically, the heating of the flat blank is done in a conventional furnace with a length of approximately 40 m; blanks, in particular 1.5 mm thick, pass through this furnace for three minutes, for example.

Furthermore, some experiments in heating such blanks by applying hot metal bodies have already been carried out.

This is accompanied by a multitude of problems.

In classic radiation furnaces, it is disadvantageous that they require a large amount of space, since the furnaces are relatively large in structure. Furthermore, it is disadvantageous that in the event of a malfunction, a high rejection rate occurs, since all of the plates in the furnace, because they have remained in the furnace for longer than planned, are no longer usable. Even in normal operation, pronounced oxidation of the surface occurs, which is unwanted.

DE 10 2014 101 539 A1 has disclosed a hot formed piece for producing hot-worked and press hardened sheet metal products from metal blanks, which includes a heating station and a shaping station. The heating station has a lower tool and an upper tool, between which a metal blank is received for being heated. The warming or heating of a metal blank in the heating station is done by indirect resistance heating. The heat is generated outside the metal blank and reaches the metal blank itself by heat conduction. To that end, the lower tool and/or the upper tool as well have an electrical resistance heater with at least one surface heating element. According to the invention, the surface heating element is a heating blank with a plate body of an electrically conductive material; the plate body is embodied as a heat conductor. To that end, the heat body is slotted and for instance provided with a slot which extends over the thickness of the plate body.

DE 10 2009 007 826 A1 has disclosed a heating apparatus for heating a metal blank, which has a lower heating unit and an upper heating unit. These heating units can be moved between a closed heating position, in which they receive the blank between them, and a release position, in which they are spaced apart from one another. Each heating unit has a heatable heating plate that comes into contact with the blank. In this case, the heating plate of the lower and/or upper heating unit includes many heating segments, which are positioned in a predetermined pattern relative to one another and which, in the plane defined by a contact face between the heating segments and the blank, are displaceable relative to one another.

DE 10 2014 101 891 A1 has disclosed a system for heating workpieces, in particular for a hot-forming station, which has a heating device and at least one goods carrier to be transported through the warmup device. The goods carrier can be equipped with a workpiece and is provided with a tempering component for conductive heating of the workpiece; the warmup device has a movable electrode for electrically contacting the tempering component.

In the known plate systems, it is disadvantageous that inductively heated plates have a low efficiency, and the power distribution can be regulated only very poorly. The ceramic heating elements already proposed also suffer from the fact that they have a short service life, that the power distribution is likewise poorly regulated, and that in many small elements, the control complexity is quite high.

Known meandering solutions likewise have the disadvantage that the power distribution is unfavorable.

It is the object of the invention to create an apparatus for heating sheet steel parts with which it is ensured that the flat blanks can be heated quickly and as homogeneously as possible, in the least possible space, with little rejection if malfunctions occur, and furthermore with which improved corrosion protection is ensured.

This object is attained by an apparatus with the features of claim 1. Advantageous refinements are defined by the claims dependent thereon.

It is a further object of the invention to create a method for heating sheet steel components using the apparatus.

That object is attained with a method having the features of claim 12.

Advantageous modifications are defined by the claims dependent thereon.

According to the invention, the blanks are heated using heating modules embodied according to the invention. A heating of the flat blanks takes place under hot plates; the requisite high power density and above all the uniform temperature distribution can be achieved by a material with good heat conductivity, preferably copper, and electrical heating. According to the invention, mineral-insulated heat conductors are cast into copper so that maximum power densities can be achieved. Alternatively, other electrical heating elements such as high-temperature heating cartridges are conceivable as well.

According to the invention, an optimal temperature homogeneity and the possibility of parts having various properties is attained by means of modular design and modular control. Particularly if a plurality of separately regulated heating modules are used for one blank surface, the mechanical properties can be adjusted very precisely by means of different grades of hardness.

According to the invention, the copper is advantageously protected against oxidation in that the copper and hence also the heat conductors cast into the copper, are hermetically sealed in a heatproof stainless steel housing.

Additionally, the plates can advantageously be provided—for the sake of longer service lives and the least possible adhesions of layers of corrosion and in particular zinc—with very wear-resistant and smooth coatings, which can consist for instance of chromium carbide or aluminum oxide and other known coatings.

The invention will be described in exemplary fashion based on the drawings. In the drawings:

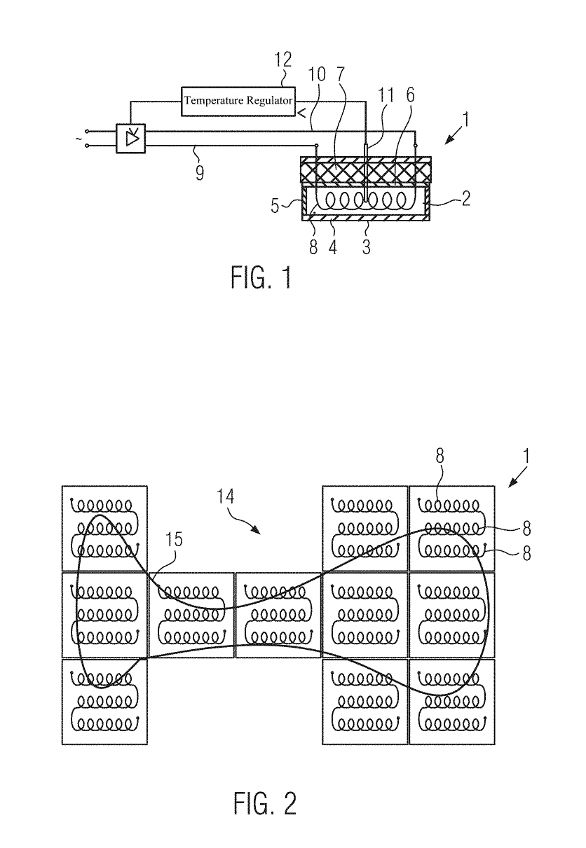

FIG. 1 is a highly schematic depiction of a heat module according to the invention;

FIG. 2 is a highly schematic view of an arrangement of a plurality of heating modules with a blank positioned beneath them;

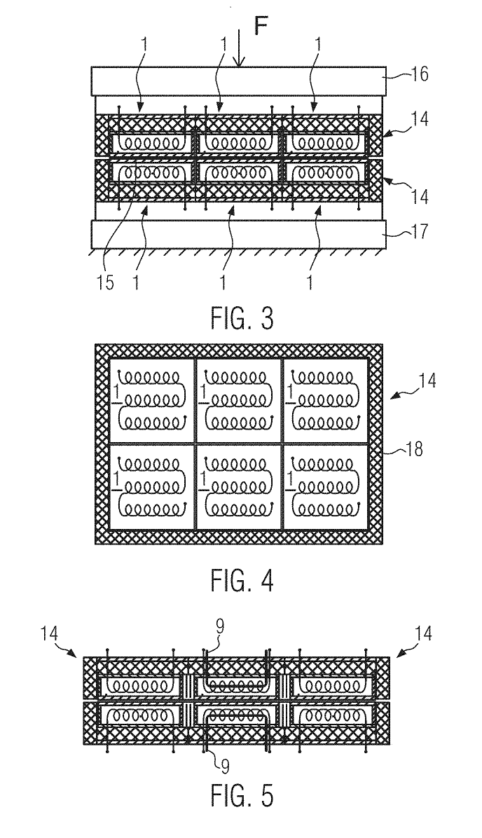

FIG. 3 is a highly schematic view of a transverse section through a heating press for blanks with a plurality of heating modules;

FIG. 4 shows the apparatus from FIG. 3 in a horizontal section through the heating modules;

FIG. 5 shows a heating module arrangement having upper and lower heating modules, in which middle heating modules furthermore have an active cooling in order to produce components with different mechanical properties;

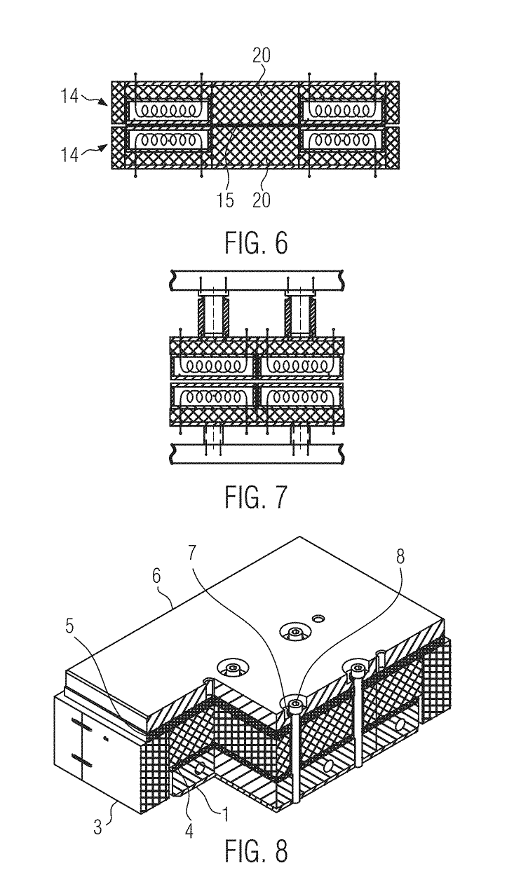

FIG. 6 shows a modular arrangement with built-in nonfunctioning modules, in order not to heat certain areas of components;

FIG. 7 shows an arrangement of heating modules with guide bolts and springs for generating a uniform surface pressure and to prevent tilting;

FIG. 8 shows a perspective, partially sectional view of a heating module according to the invention that has heating cartridges and a copper core;

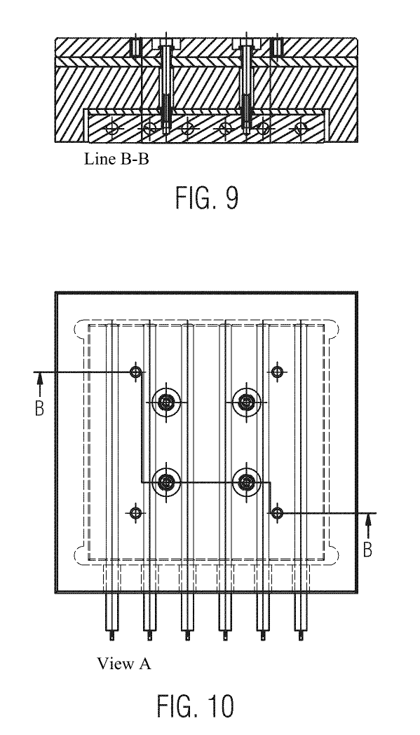

FIG. 9 shows a vertical section through the heating module from FIG. 8;

FIG. 10 shows a horizontal section through the heating module from FIG. 8;

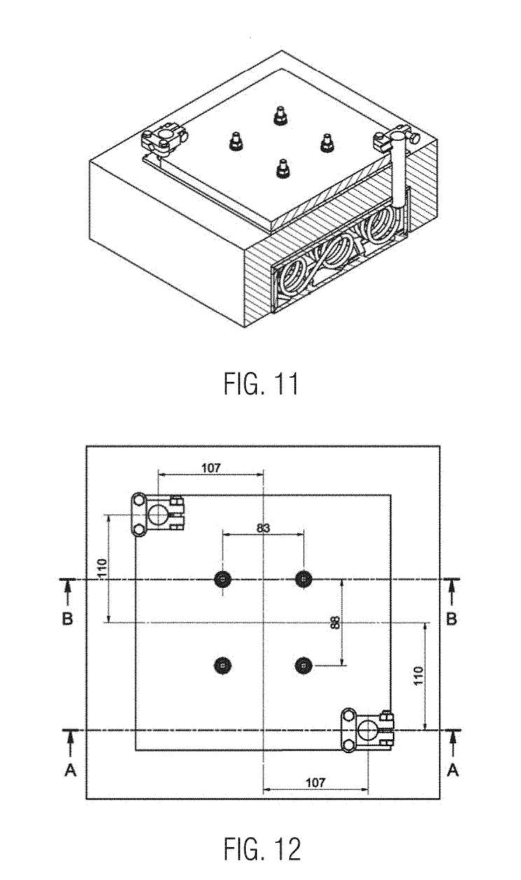

FIG. 11 shows a cutaway perspective view of the heating module with a mineral-insulated heating cable and a copper core;

FIG. 12 shows a top view of the heating module from FIG. 12;

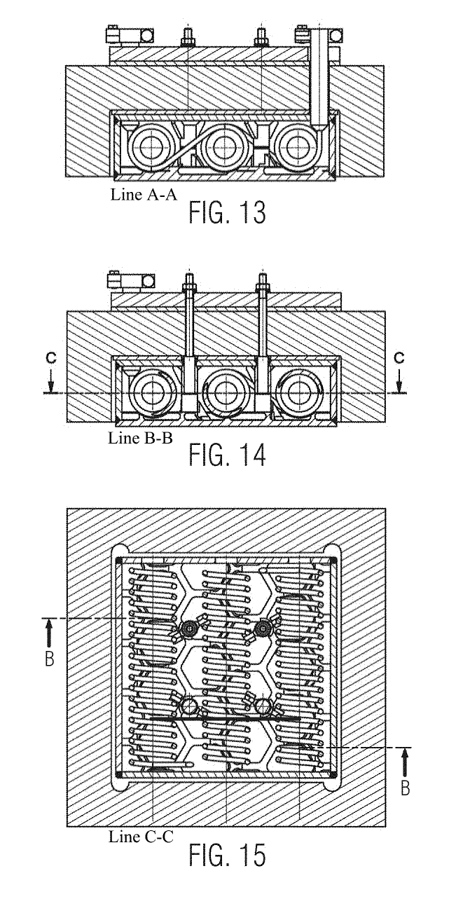

FIG. 13 shows the heating module from FIG. 13 in a sectional view corresponding to the section line A-A;

FIG. 14 shows the heating module from FIG. 12 in a sectional view corresponding to the section line B-B;

FIG. 15 shows the heating module from FIG. 12 in a horizontal section corresponding to the line C-C in FIG. 15;

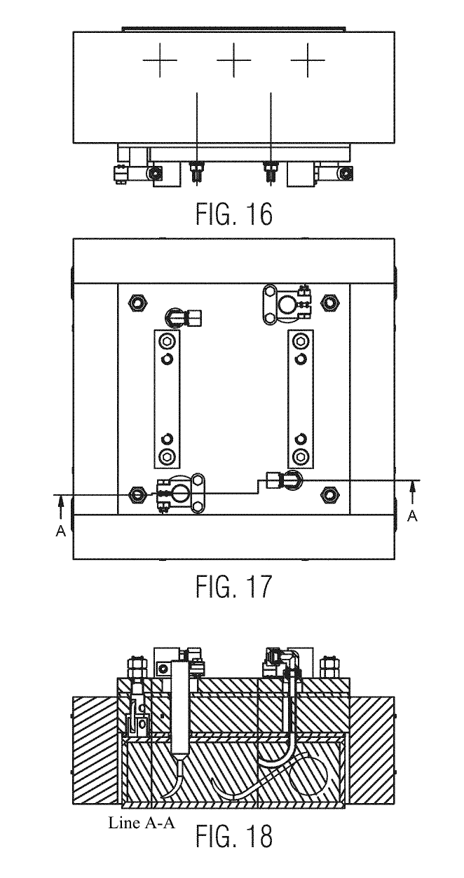

FIG. 16 shows a side view of the heating module;

FIG. 17 shows a further embodiment of the heating module of the invention having a cooler;

FIG. 18 shows the heating module from FIG. 17 in a section along the line A-A;

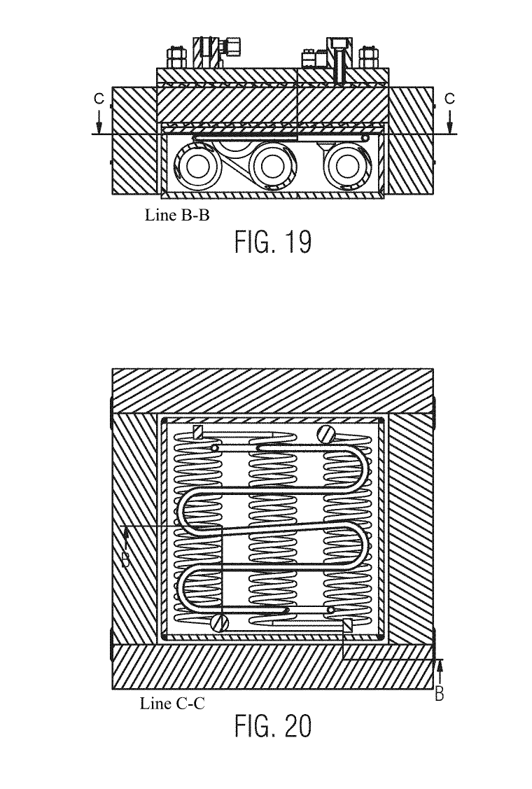

FIG. 19 shows the heating module from FIG. 17 in a sectional view along the line B-B;

FIG. 20 shows the heating module from FIG. 19 in a sectional view along the line C-C;

FIG. 23 shows a perspective view, partly in section, along the line A-A in FIG. 17;

FIG. 24 shows the heating curve a 1.5 mm thick steel sheet between plates heated to 870° C.

A heating module 1 according to the invention is a boxlike element embodied in cassette-like fashion, which has a plate-shaped or rectangular cavity 2 that has a flat plate 4 on an underside 3, as well as side walls 5 that extend perpendicularly from the plate and a cover plate 6, which define the boxlike element 2 on all sides. Toward the top, an insulator 7 is positioned on the plate 6.

Heating coils or heating elements 8, which can be subjected to current via an ingoing and an outgoing line 9, 10, are positioned in the cavity 2. Additionally and advantageously, a temperature sensor 11 can be present, which is connected to a temperature regulator 12 that regulates the flow of current.

Particularly in the case of a rectangular heating module 1, a plurality of mineral-insulated heating coils 8 are connected in series and are positioned side by side, so that the heating module can be heated over the entire surface.

In addition to the heating elements 8, cooling hoses or lines 9 (FIG. 5) may be present, so that the heating modules can not only be heated but also in particular cooled down relative to adjacent heating modules.

A plurality of heating modules 1 can be combined into a heating device 14, which for instance includes modules 1 arranged in such a way that they suitably cover a blank 15 that is to be heated.

Preferably, the heating modules 1 are each positioned inside a respective heating device 14 and the heating device 14 can be positioned either on an upper part 16 of a heating press or a lower part 19 of a heating press, or both; these parts are movable toward and away from one another, so that between the heating modules 1 of the respective heating devices 14, a blank 15 can be clamped in place and heated.

A corresponding heating device 14 can for instance include six modules 1 (FIG. 4) and the modules are surrounded peripherally to the heating device 14 by an insulator 18. The number of modules, however, is arbitrary.

The heating devices 14 can also have, at preferred locations, cooled heating modules with cooling lines 9 and/or empty modules 20 or insulator blocks of insulator material, in the vicinities of which no heating takes place (FIG. 6).

According to the invention, the cavity 2 is filled with copper so that the heat conductors 8 are insulated from the copper by a non-electrically conductive mineral insulator and are completely enclosed by and embedded in the copper, in order to ensure especially good heat transfer. The plate 4, the side walls 5, and the ceiling wall 6 are preferably embodied of heat-resistant or highly heat-resistant stainless steel and ideally are hermetically sealed in the highly heat-conductive core, in particular copper core, in order to prevent oxidation of the core.

In a further advantageous embodiment, the heating module 1 likewise has a copper core, but with heating cartridges. The heat modules 1 here are also embodied with a complete insulator in the vicinity of the outer walls 5 (FIGS. 8, 9, 10).

In a further advantageous embodiment (FIGS. 11 through 15), the heating modules are likewise embodied with mineral-insulated heat conductors and the copper core; the heating modules, in the embodiment as a single module, have a uniform insulator 20 with a C-shaped cross section in the vicinity of the side walls and the sealing wall; and the insulator 20 contains the actual heating region, consisting of the copper-filled stainless steel box with the mineral-insulated heat conductor.

In order to secure the box to the insulator 20, there are connecting elements 21 in the box, which are embodied in particular as threaded columns that extend upward through the insulator 20 and, on the top side 22 of the insulator, extend through a counterpart bearing plate 23 and are screwed onto it. Furthermore, contact poles 24 are positioned on the counterpart bearing plate 23, which extend through the counterpart bearing plate 23 and the insulator 22 and are embodied so that they contact the heating elements 8.

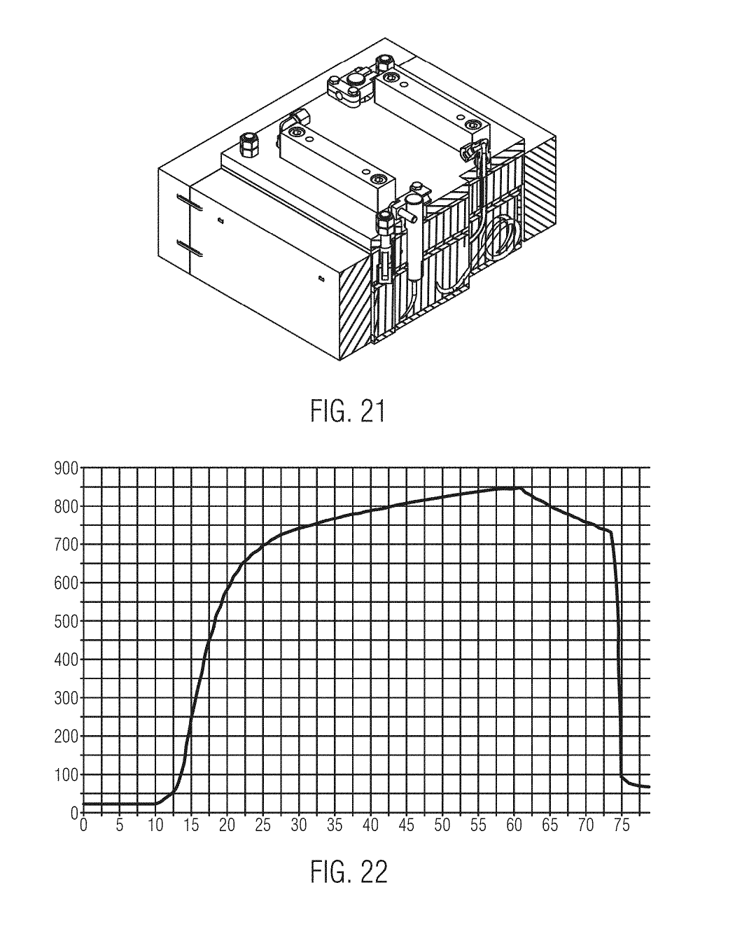

In a further advantageous embodiment (FIGS. 17 through 23), the heating module is likewise embodied in such a way that the stainless steel box 2, filled with copper and including the heating cables 8 positioned as heating coils, additionally includes a cooling device in the form of a cooling hose 25 or cooling lines 25, and the cooling hose 25 from the outside is provided with an inlet 26 and an outlet 27.

The inlet 26 and outlet 27 extend through both the insulator 20 and the plate 6 and reach into the interior of the copper core.

In the combination of heating modules 1, the insulators 20 can be removed, except for the ceiling insulator, between the plate 6 and the counterpart bearing plate 23, so that the heating modules contact one another and make uniform heating or cooling possible, without temperature bridges.

In the invention it is advantageous that—by coupling mineral-insulated heating lines on the one hand and a copper core on the other, combined with a heat-proof stainless steel plate on the blank—especially good and highly effective heat transfer is achieved.

From the heating cores (FIG. 24), it can be seen that within a few seconds, a steel blank of this kind that is 1.5 mm thick is heated under hot plates (preferably tempered to higher than 870° C.) to above the Ac3 of the material, for instance to 850° C., and in particular the temperature range up to 700° C. is traversed very quickly. “Very quickly” means that this takes approximately 10 seconds.

In the invention it is advantageous that the use of non-heated or water-cooled modules in a heating device allows certain regions, which are not be hardened, to be left unheated. This makes it possible to embody blanks with different microstructures, so that as a result, after the press hardening, components with different mechanical properties (taylored property parts=TPP) are attained.

1. An apparatus for heating sheet steel blanks comprising a heating device (14) and the heating device (14) comprises at least one heating module (1); the at least one heating module (1) having a boxlike element embodied in cassette-like fashion, which has a plate-shaped or rectangular cavity (2) that has a flat plate (4) on an underside (3); at least one heating element (8) is positioned in the cavity (2), which element is embodied as an electrical resistance heating element; the cavity (2) is completely filled in embedding fashion so that it is completely enclosed by a highly heat-conductive material, preferably copper; and the plates (4) surrounding the cavity (2) or copper-filled cavity (2), the side walls (5), and the ceiling wall (6) are embodied of heat-resistant or highly heatproof stainless steel and are joined to one another in such a way that the core of highly heat-conductive material, in particular copper core, is hermetically sealed off.

2. The apparatus according to claim 1, characterized in that the heating module (1) additionally includes cooling lines (9) for cooling the module (1).

3. The apparatus according to claim 1, characterized in that the heating device (14) has heating modules (1) with heating elements (8) and/or heating modules (1) with heating elements (8) and cooling lines (9), and/or modules, which are neither heated nor cooled.

4. The apparatus according to claim 1, characterized in that a heating device (14) having at least one heating module (1) is positioned on a heating press upper part (16) and/or a heating press lower part (17), which are movable toward and away from one another, so that between the heating modules (1) of the heating device (14), a blank (15) can be clamped in place and heated.

5. The apparatus according to claim 1, characterized in that the heating device (14) has unheated or cooled heating modules (1) in places where a blank is not intended to be hardened.

6. (canceled)

7. The apparatus according to claim 1, characterized in that the heating module (1), in a singular arrangement in a heating device (14), are embodied with an insulator (20) in the vicinity of the outer walls (5) and in the vicinity of the ceiling wall (6).

8. The apparatus according to claim 1, characterized in that the insulator (20) is embodied as C-shaped in cross section, and in order to secure the box (2) to the insulator (20), there are connection elements (21) in the box, which extend through the insulator (20) from the plate (4), and on the top side (22) of the insulator, there is a counterpart bearing plate (23), which is penetrated thereby and the connection elements (21) are bonded to it.

9. The apparatus according to claim 1, characterized in that contact poles (24), which are positioned on a side of the heating module (1) opposite from the plate (4), are embodied so that they contact the heating elements (8).

10. The apparatus according to claim 1, characterized in that in a heating module (1) with a cooling line (9), the cooling line from the outside is embodied with an inlet (26) and an outlet (27), and the inlet (26) and outlet (27) extend through the insulator (20) and the plate (6) and extend into the copper core, so that they can be supplied with coolant by the cooling line (9, 25).

11. The apparatus according to claim 1, characterized in that in a heating device (14) with a plurality of heating modules (1), the insulators (20) are embodied in such a way that between uninsulated side walls (5) of the heating modules (1), they are positioned in direct contact with one another.

12. The apparatus of claim 1, characterized in that the heating element is embodied as a heating cartridge or a mineral-insulated heat conductor.

13. A method for operating an apparatus according to claim 1, wherein the sheet steel blank is subjected to heat on at least one side; the sheet steel blank is put into contact with a plate (4) of a heating module (1) of a heating device (14); and the heating module (1) is electrically heated and the heat in the heating module is transferred from an electric resistance heating element (8) to a highly heat-conductive core, preferably a copper core, and from this core, preferably a copper core, to the plates (6) and from the plate (6) to the blank.

14. The method according to claim 13, characterized in that a heating device (14) is embodied with a plurality of heating elements (8), and the blank of the plurality of heating devices (8) is selectively heated, not heated, or cooled.
